(19) United States
(12) Patent Application Publication
(10) Pub. No.: US 2016/0233721 A1
(43) Pub. Date: Aug. 11, 2016

(54) NON-INTERRUPTIBLE ELECTRIC POWER SUPPLY SYSTEM WITH SOUND POWER GENERATION

(71) Applicant: DO HUN OH, Gyonggi-do (KR)

(72) Inventor: DO HUN OH, Gyonggi-do (KR)

(21) Appl. No.: 14/949,887

(22) Filed: Nov. 24, 2015

(30) Foreign Application Priority Data
Feb. 9, 2015 (KR) 10-2015-0019164

(51) Int. Cl. H02J 9/06; H02M 7/44; H02K 35/00; H02J 7/00

(52) U.S. Cl. CPC H02J 9/061; H02J 7/0068; H02M 7/44; H02K 35/00

(57) ABSTRACT

A non-interruptible electric power supply system including: a battery charger which charges power from an external power source into an internal battery, and discharges the power charged in the internal battery after a supply from the external power source is discontinued; a noise generator which gathers a noise generated by a normal driving of an industrial apparatus not to be scattered in all directions; a sound power generator including a vibration plate where vibration is generated by a sound collected from the noise generator, a vibration pole which is vertically fixed at an end of the vibration plate and repeats ascending or descending, and an electric converter which generates electricity from an electric field variation generated according to the ascending or descending of the vibration pole upward or downward; and an inverter converting direct current delivered from the sound power generator into alternating current and outputs the alternating current.

### TECHNICAL FIELD

The present invention relates to a non-interruptible electric power supply system, more specifically to a non-interruptible electric power supply system with sound power generation which converts a certain level or higher of noise generated from a motor, etc., which is mainly used in an industrial site, into electricity, thereby increasing power generation efficiency.

### BACKGROUND ART

Korean Patent No. 10-0964597 (Uninterrupted power supply) discloses, “An uninterrupted power supply (UPS) includes a battery, a balance node, a first power converting circuit, and a second power converting circuit. The battery stores energy. The balance node is connected to an AC input power through a switch. The first power converting circuit is connected to the balance node, battery and load, and adjusts a voltage level applied to the load by charging and discharging the energy of the battery. The second power converting circuit is connected to the balance node and battery, and adjusts current inflowed into or outflowed from the balance node and current inflowed into or outflowed from the load by charging and discharging the energy of the battery.”

However, the conventional non-interruptible electric power supply system charges power into the battery at ordinary time and discharges the power charged in the battery outside in an emergency. Thus, energy efficiency thereof is not good.

Furthermore, in order to extend the dischargeable time in case of an emergency of the non-interruptible electric power supply system, energy efficiency or battery capacity needs to be increased. However, recently, there is a limit in terms of structure, and battery-related costs are excessively increased for increasing the battery capacity unlimitedly.

### RELATED ART REFERENCE

Korean Patent No. 10-0964597

### SUMMARY OF INVENTION

The present invention aims to solve the above-mentioned problems. It is an object of the present invention to provide a non-interruptible electric power supply system with sound power generation which converts a noise into electricity using the speaker principle, thereby increasing efficiency, compared to the conventional system.

In order to achieve the above-object, the present invention provides a non-interruptible electric power supply system, including a battery charger which charges power into an internal battery from a household power source or an industrial power source, and discharges the power charged in the internal battery after the supply from the household power source or industrial power source is discontinued; a noise generator which gathers a noise generated by a normal driving of an industrial apparatus not to be scattered in all directions; a sound power generator which includes a vibration plate where vibration is generated by a sound collected from the noise generator, a vibration pole which is vertically fixed at an end of the vibration plate and repeats ascending or descending, and an electric converter which generates electricity from an electric field variation generated according to the ascending or descending of the vibration pole upward or downward; and an inverter which converts direct current delivered from the sound power generator into alternating current and outputs the alternating current.

The noise generator and sound power generator of the present invention are preferably encased by a plurality of vacuum walls.

The vibration plate of the present invention has an inner diameter which becomes wider outside. An outer diameter and the inner diameter of the vibration plate preferably include a plate which is thin enough to vibrate by an external sound.

In the present invention, a gap between the vacuum walls is preferably in a vacuum state.

In the present invention, the noise generator may be a motor.

According to a preferable effect of the present invention, the present invention uses a noise which can be commonly collected and dumped in an industrial site as a generation source, thereby increasing efficiency of a non-interruptible electric power supply system without additionally increasing battery capacity or increasing the number of battery.

### BRIEF DESCRIPTION OF THE DRAWINGS

FIG. 1 is a block diagram illustrating a schematic constitution of a non-interruptible electric power supply system with sound power generation according to the present invention;

FIG. 2 is a cross-sectional view illustrating a main part of a sound power generator of a non-interruptible electric power supply system according to the present invention;

FIG. 3 is an exploded perspective view illustrating the disassembly of constitutional elements of FIG. 2;

FIG. 4 is a cross-sectional view illustrating an arrangement of a sound power generator of a non-interruptible electric power supply system according to a first embodiment of the present invention; and

FIG. 5 is a cross-sectional view illustrating an arrangement of a sound power generator of a non-interruptible electric power supply system according to a second embodiment of the present invention.

### BEST MODE FOR CARRYING OUT THE INVENTION

Hereinafter, the present invention will be explained in detail with reference to the attached drawings.

For reference, the present invention relates to a non-interruptible electric power supply system with sound power generation. However, a power generation circuit and a circuit for supplying non-interruptible electric power may be fully implemented with the currently published technologies alone, so the detailed description thereof will be omitted. The main constitution of the present invention, which is the constitution of sound collection, will be explained in detail.

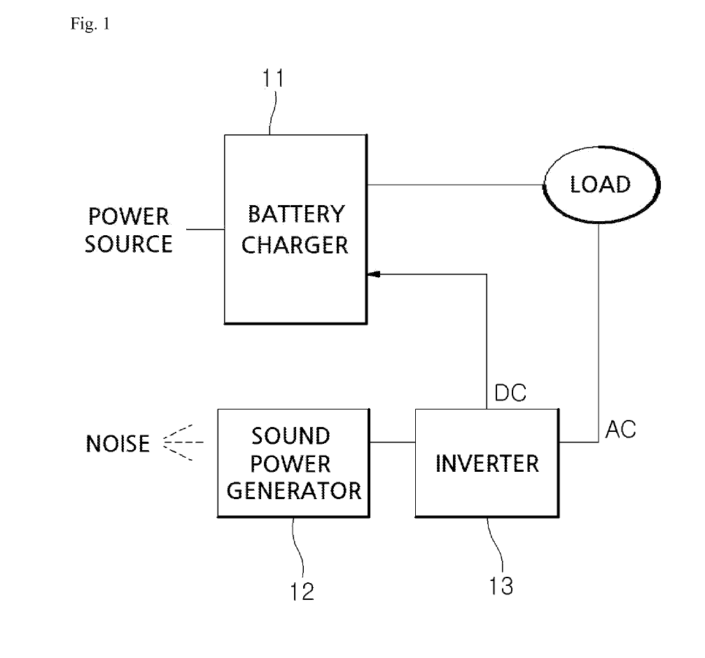

FIG. 1 is a block diagram illustrating a schematic constitution of a non-interruptible electric power supply system with sound power generation according to the present invention. The non-interruptible electric power supply system includes a battery charger 11 which charges power into an internal battery from a household power source or an industrial power source, and discharges the power charged in the internal battery after the supply of the household power source or industrial power source is discontinued.

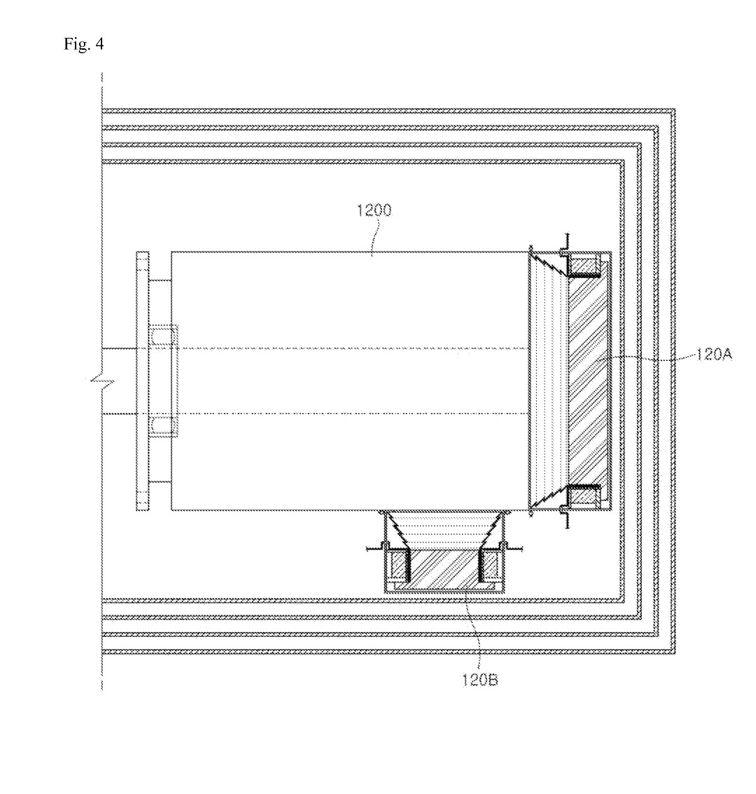

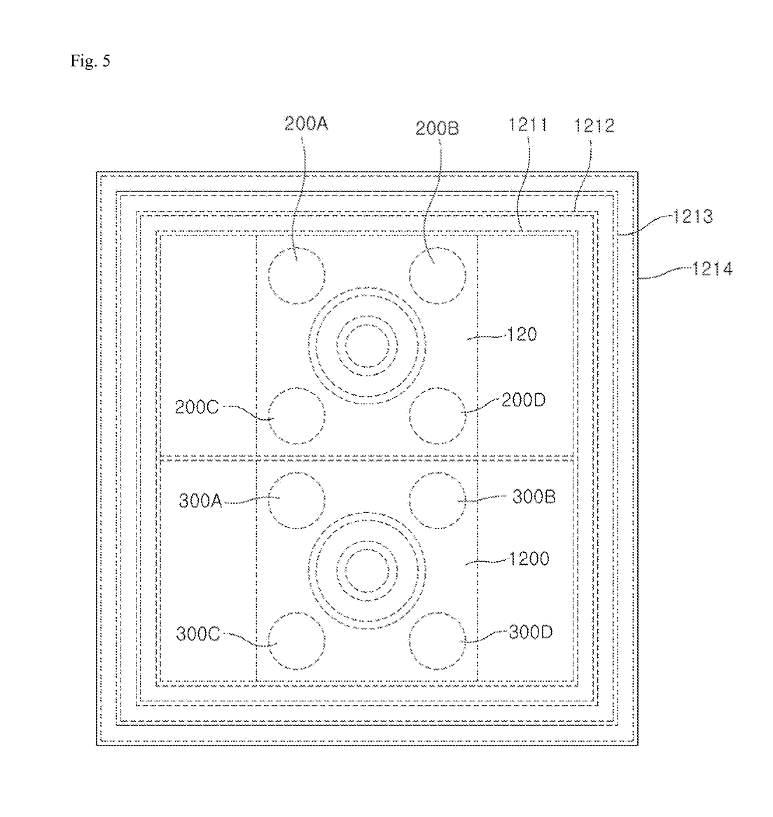

In this case, as illustrated in FIG. 4 and FIG. 5, the non-interruptible electric power supply system includes a noise generator 1200 which gathers a noise generated by a normal driving of an industrial apparatus not to be scattered in all directions.

Additionally, the non-interruptible electric power supply system includes a sound power generator 12 including a vibration plate where vibration is generated by a sound collected from the noise generator 1200, a vibration pole which is vertically fixed at an end of the vibration plate and repeats ascending and descending, and an electric converter which generates electricity from an electric field variation generated according to the ascending or descending of the vibration pole upward or downward, and an inverter 13 which converts direct current delivered from the sound power generator 12 into alternating current and outputs the alternating current.

A structural characteristic of the sound power generator 12 collecting the sound to be used as a power generation source will be explained in detail.

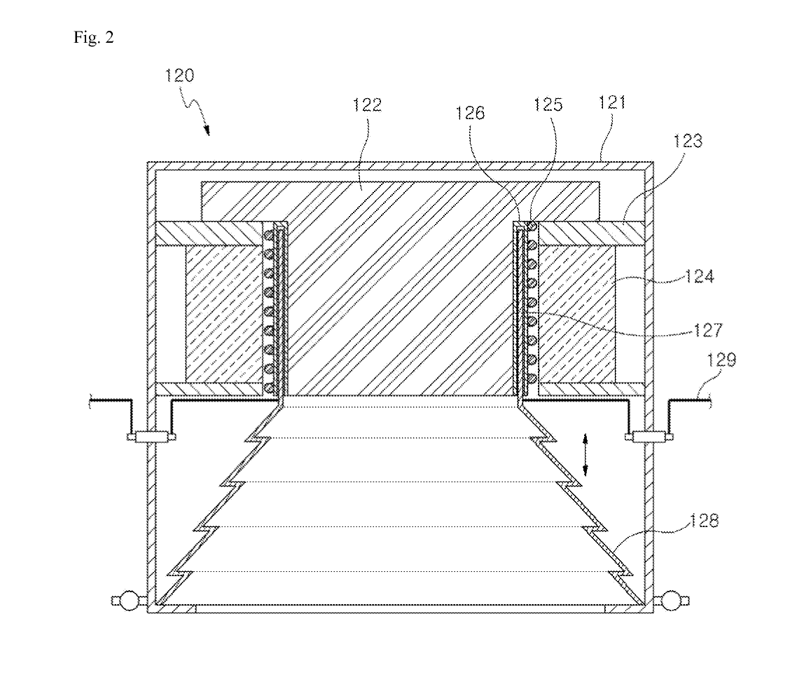

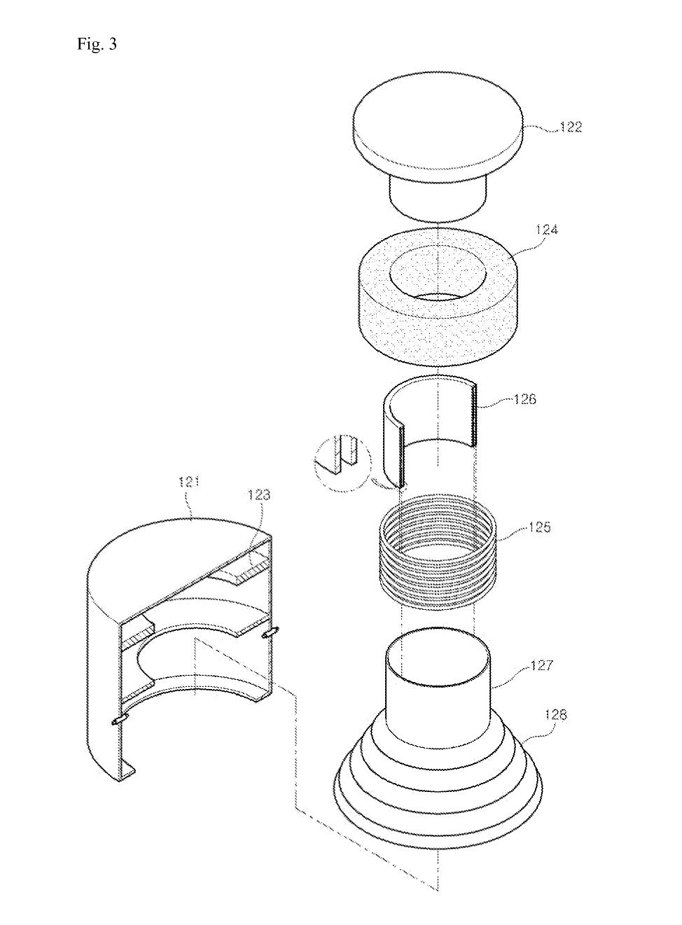

FIG. 2 is a cross-sectional view illustrating a main part of a sound power generator of a non-interruptible electric power supply system according to the present invention. FIG. 3 is an exploded perspective view illustrating the disassembly of constitutional elements of FIG. 2.

Referring to FIG. 2 and FIG. 3, a sound power generating body 120 includes a vibration plate 128 which gathers a noise collected and vibrates due to the noise. When an upward and downward movement is made as the vibration plate 128 vibrates, a vibration pole 127 fixed at an end of the vibration plate moves upward and downward.

As such, the upward and downward movement of the vibration pole 127 triggers a magnetic field variation due to current passing through a coil 125 which is wound on an external circumference of an annular guide 126 which surrounds the vibration pole 127. The coil 125 allows electricity to flow, to form a magnetic field by the current.

An induced electromotive force is generated between magnetic fields of a magnetic 124 arranged at an outer edge of the sound power generating body, which is used as a power generation source. According to the necessity, the vibration pole 127 may be made of a permanent magnetic to increase the induced electromotive force.

Meanwhile, a case 121 is electrically blocked from outside, to minimize an influence of an external electric field or an external magnetic field. A main body 122 has a ‘T’-shaped cross-section so as to support each constitutional element.

A support plate 123 has a circle shape which opens in the middle so as to support the magnetic 124 and coil 125 inside, and includes an electrical connecting part 129 for outputting electricity generated.

The sound power generating body 120 with the above-mentioned constitution may be carried out as in a first embodiment illustrated in FIG. 4, or may be carried out as in a second embodiment illustrated in FIG. 5. The sound power generating body may be properly selected according to a situation of a place of business.

FIG. 4 is a cross-sectional view illustrating an arrangement of a sound power generator of a non-interruptible electric power supply system according to the first embodiment of the present invention. FIG. 5 is a cross-sectional view illustrating an arrangement of a sound power generator of a non-interruptible electric power supply system according to the second embodiment of the present invention

For reference, for the first and second embodiments, it is proper in terms of efficiency to arrange the noise generator 1200 and sound power generating body 120 to be adjacent to each other. First, second, third and fourth vacuum walls 1211, 1212, 1213 and 1214 are provided outside. In this case, a gap between the first, second, third and fourth vacuum walls 1211, 1212, 1213 and 1214 is in a vacuum state, and an innermost and an outermost thereof are not in a vacuum state.

Referring to FIG. 4, by arranging the sound power generating bodies 120A and 120B at a lateral end or a lower end of a rotational axis of a noise source like a motor, which is a main noise source in an industrial site, efficiency of noise collection may be increased while a worker may not hear that noise.

Referring to FIG. 5, an outer case of the sound power generating body 120 includes a plurality of holes 200A, 200B, 200C and 200D, and an outer case of the noise generator 1200 includes a plurality of holes 300A, 300B, 300C and 300D, so as for the noise to be distributed inside, without leakage outside.

What is claimed is:

1. A non-interruptible electric power supply system with sound power generation, the system comprising:
a battery charger which charges power into an internal battery from a household power source or an industrial power source, and discharges the power charged in the internal battery after the supply from the household power source or industrial power source is discontinued;
a noise generator which gathers a noise generated by a normal driving of an industrial apparatus not to be scattered in all directions;
a sound power generator which includes a vibration plate where vibration is generated by a sound collected from the noise generator, a vibration pole which is vertically fixed at an end of the vibration plate and repeats ascending or descending, and an electric converter which generates electricity from an electric field variation generated according to the ascending or descending of the vibration pole upward or downward; and
an inverter which converts direct current delivered from the sound power generator into alternating current and outputs the alternating current.

2. The system of claim 1, wherein the noise generator and the sound power generator are encased by a plurality of vacuum walls.

3. The system of claim 1, wherein the vibration plate has an inner diameter which becomes wider outside, wherein an outer diameter and the inner diameter of the vibration plate include a plate which is thin enough to vibrate by an external sound.

4. The system of claim 2, wherein a gap between the vacuum walls is in a vacuum state.

5. The system of claim 1, wherein the noise generator is a motor.
